(19) United States
(12) Patent Application Publication
(10) Pub. No.: US 2018/0242017 A1
(43) Pub. Date: Aug. 23, 2018

(54) TRANSCODING VIDEO

(71) Applicant: Twitter, Inc., San Francisco, CA (US)

(72) Inventors: Sebastiaan Van Leuven, London (GB); Zehan Wang, London (GB)

(21) Appl. No.: 15/859,568

(22) Filed: Dec. 31, 2017

Related U.S. Application Data
(60) Provisional application No. 62/462,229, filed on Feb. 22, 2017.

(51) Int. Cl. H04N 19/597; H04N 19/162; H04N 19/147; H04N 19/192

(52) U.S. Cl. CPC H04N 19/597; H04N 19/192; H04N 19/147; H04N 19/162

(57) ABSTRACT

A method includes receiving one of a first encoded video data representing an 2D representation of a frame of omnidirectional video, and a second encoded video data representing a plurality of images each representing a section of the frame of omnidirectional video, receiving an indication of a view point on the omnidirectional video, selecting a portion of the omnidirectional video based on the view point, encoding the selected portion of the omnidirectional video, and communicating the encoded omnidirectional video in response to receiving the indication of the view point on the omnidirectional video.

### CROSS-REFERENCE TO RELATED APPLICATION

This application is a Nonprovisional of, and claims priority to, U.S. Patent Application No. 62/462,229, filed on Feb. 22, 2017, entitled “TRANSCODING VIDEO”, which is incorporated by reference herein in its entirety.

### FIELD

Embodiments relate to encoding and decoding a streaming video.

### BACKGROUND

Typically, a streaming server encodes a two-dimensional (2D) representation of an omnidirectional video and communicates a portion of the encoded 2D representation to a device capable of rendering omnidirectional video. The device then decodes the 2D representation, converts the decoded 2D representation to omnidirectional video and renders the omnidirectional video.

### SUMMARY

Example embodiments describe techniques for encoding, decoding and streaming omnidirectional video. In a general aspect, a method includes receiving one of a first encoded video data representing an 2D representation of a frame of omnidirectional video, and a second encoded video data representing a plurality of images each representing a section of the frame of omnidirectional video, receiving an indication of a view point on the omnidirectional video, selecting a portion of the omnidirectional video based on the view point, encoding the selected portion of the omnidirectional video, and communicating the encoded omnidirectional video in response to receiving the indication of the view point on the omnidirectional video.

In another general aspect, an edge node in a network includes a processor and an encoder. The processor is configured to receive one of a first encoded video data representing an 2D representation of a frame of omnidirectional video, and a second encoded video data representing a plurality of images each representing a section of the frame of omnidirectional video. The processor is further configured to receive an indication of a view point on the omnidirectional video. The encoder is configured to select a portion of the omnidirectional video based on the view point, and encode the selected portion of the omnidirectional video. The processor is further configured to communicate the encoded omnidirectional video in response to receiving the indication of the view point on the omnidirectional video.

Implementations can include one or more of the following features. For example, the method can further include (or a decoder can) decoding the second encoded video data to reconstruct the plurality of images, and generating the frame of omnidirectional video by stitching the plurality of images together. Decoding the first encoded video data to reconstruct the 2D representation of the frame of omnidirectional video, and generating the frame of omnidirectional video by mapping the 2D representation of the frame of omnidirectional video to the frame of omnidirectional video. The frame of omnidirectional video can be translated prior to encoding the selected portion of the omnidirectional video.

For example, the method can further include applying a rate-distortion optimization, wherein the rate-distortion optimization uses information based on encoding a previous frame of the omnidirectional video and/or the previously encoded representation of the omnidirectional video and a trained hierarchical algorithm. Generating a list of decisions to be evaluated for a rate-distortion optimization, and applying the rate-distortion optimization. The rate-distortion optimization can use the list of decisions, information based on encoding a previous frame of the omnidirectional video, information from the previously encoded representation of a same frame of the omnidirectional video, and/or a trained hierarchical algorithm. The encoding uses a trained convolutional neural network model to encode the selected portion of the omnidirectional video, and communicating the trained convolutional neural network model with the encoded omnidirectional video. The method, the encoder and/or a decoder can be implemented using a non-transitory computer readable medium having code segments stored thereon, the code segments being executed by a processor.

In still another general aspect, a viewing device includes a processor and a decoder. The processor can be configured to communicate a view point to an edge node in a network, and receive encoded video data from the edge node in response to communicating the view point, the encoded video data representing a portion of a frame of omnidirectional video. The decoder can be configured to decode the encoded video data to reconstruct the portion of the frame of omnidirectional video.

Implementations can include one or more of the following features. For example, the processor can be configured to receive a trained convolutional neural network model, and the decoder can be configured to decode the encoded video data using the trained convolutional neural network model. The decoder can be configured to use a super resolution technique to increase a resolution of the portion of the frame of omnidirectional video. The encoded video data represents a plurality of portions of the frame of omnidirectional video encoded a different resolutions, the decoder can be configured to generate a plurality of reconstructed portions of the frame of omnidirectional video, and the decoder can be configured to use a super resolution technique to increase a resolution of at least one of the plurality of reconstructed portions of the frame of omnidirectional video.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a block diagram of a signal flow for streaming omnidirectional video according to at least one example embodiment.

FIG. 2A illustrates a frame of a omnidirectional video according to at least one example embodiment.

FIG. 2B illustrates a block diagram of a 2D cubic representation of a frame of a omnidirectional video according to at least one example embodiment.

FIGS. 3, 4, 5 and 6 are flowcharts of a method for encoding/decoding a video frame according to at least one example embodiment.

FIG. 7A illustrates a video encoder system according to at least one example embodiment.

FIG. 7B illustrates a video decoder system according to at least one example embodiment.

FIG. 8 illustrates a system according to at least one example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

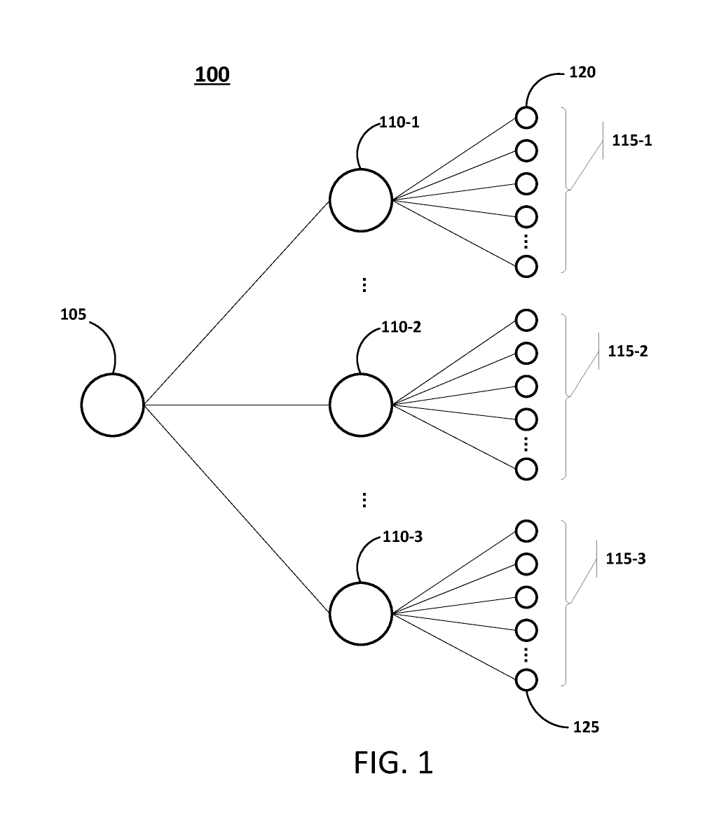

FIG. 1 illustrates a block diagram of a signal flow for streaming video according to at least one example embodiment. The video can be a virtual reality (VR) video, an omnidirectional video, a panoramic video, a 180 degree video and the like. An omnidirectional video can be a 180 degree video, a 270 degree video, a 360 degree video, a panoramic video, and the like. Henceforth, the video may be referred to as a video or an omnidirectional video. As shown in FIG. 1, a streaming system includes a streaming device 105 (e.g., a mobile computing device), a plurality of intermediate devices 110-1, 110-2, 110-3 (e.g., a content delivery network edge node) and a plurality of viewing devices 115-1, 115-2, 115-3 (e.g., a head mount display). In a typical use case, the streaming device 105 includes (or is associated with) a plurality of cameras each configured to capture a portion of a omnidirectional video. The streaming device 105 then stitches the portions of the omnidirectional video together to generate the omnidirectional video. The portion of a omnidirectional video then receives a request for the omnidirectional video (or a portion thereof) based on a view point of a viewer using one of the viewing devices 115-1, 115-2, 115-3 to play back the omnidirectional video. The streaming device 105 then encodes the portion of the omnidirectional video selected based on the view point and communicates the encoded video to one of the viewing devices 115-1, 115-2, 115-3 (e.g., viewing device 120).

However, according to example implementations, the streaming device 105 can encode the omnidirectional video and communicate the encoded omnidirectional video to the intermediate devices 110-1, 110-2, 110-3. Alternatively, the streaming device 105 can encode a plurality of images each representing a section of the omnidirectional video (as captured by each of the plurality of cameras) and communicate the plurality of encoded images to the intermediate devices 110-1, 110-2, 110-3. Each of the intermediate devices 110-1, 110-2, 110-3 can then stitch the plurality of images together to generate the omnidirectional video. The intermediate devices 110-1, 110-2, 110-3 can then stream the omnidirectional video to the viewing devices 115-1, 115-2, 115-3. In other words, the intermediate devices 110-1, 110-2, 110-3 can encode the portion of the omnidirectional video selected based on the view point of devices 115-1, 115-2, 115-3 respectively, and communicate the encoded video to one of the viewing devices 115-1, 115-2, 115-3 (e.g., intermediate device 110-1 streams video to viewing device 120). These example implementations can reduce the computing resources necessary for the streaming device 105 to stream omnidirectional video to the plurality of viewing devices 115-1, 115-2, 115-3, as the stitching only needs to be done for the areas corresponding to the requested view points.

Prior to communicating a frame (or portion of a frame) of omnidirectional video, the frame of omnidirectional video can be projected into a two-dimensional (2D) representation of the frame of omnidirectional video. In other words, during an encoding process, the frame of the omnidirectional video can be projected or mapped to a two-dimensional (2D) representation (thus allowing 2D encoding techniques to be used).

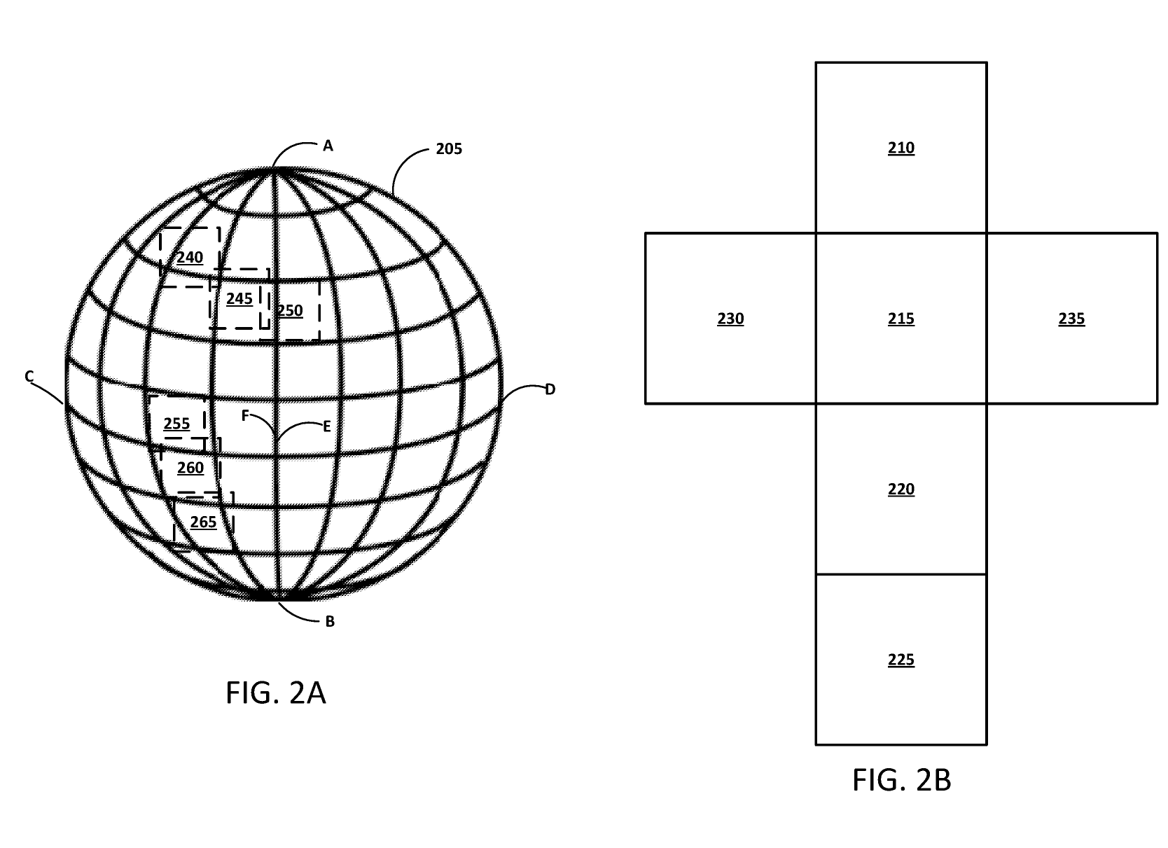

FIG. 2A illustrates a frame of a omnidirectional video according to at least one example embodiment. As shown in FIG. 2A, the sphere 205 illustrates a frame of a omnidirectional video and a portion of the frame of the omnidirectional video 240, 234, 250, 255, 260, 265 each representing a portion of the frame of omnidirectional video that would be seen by a viewer of the omnidirectional video based on a view point of the viewer.

The portion of the frame of the omnidirectional video 240, 234, 250, 255, 260, 265 each representing a portion of the frame of omnidirectional video may be a portion of the sphere 205 as viewed from the inside of the sphere 205 looking outward.

FIG. 2B illustrates a block diagram of a 2D cubic representation of a frame of a omnidirectional video according to at least one example embodiment. As shown in FIG. 2B, the 2D cubic representation has six (6) cube faces 210, 215, 220, 225, 230, 235. In the example of FIG. 2B, pole A can be mapped or projected to the center of cube face 210, pole B can be mapped or projected to the center of cube face 220. Further, equidistant positions along the equator of the sphere 205 can be mapped to the remaining cube faces. For example, point C can be mapped or projected to the center of cube face 230, point D can be mapped or projected to the center of cube face 235, point E can be mapped or projected to the center of cube face 215, and point F (directly opposite of point E if the sphere 205 were illustrated in 3D) can be mapped or projected to the center of cube face 225. Then a portion of the sphere 205 surrounding each pole A, pole B, point C, and point D can be mapped to the remainder of the corresponding cube face.

In omnidirectional video streaming the delay between user-head rotation and viewport rendering or the delay between a user moving his/her head or eyes and a new viewport being displayed should be minimized to create desired user experience. The delay should be, for example, below 20 ms. One technique for streaming omnidirectional video includes communicating all the omnidirectional video pixel data (e.g. equirectangular projection, cube map projection, and the like) from the streaming device (streaming device 105) to the viewing devices (viewing devices 115-1, 115-2, 115-3) playing back the omnidirectional video. However, this technique necessitates a high bit rate for communications over the last mile.

A viewport (e.g., the video streamed to a viewing device based on a view point of the user of the viewing device) can only be used for users watching the same view point. To serve all possible view points, N viewports should be available. When the user turns his/her head, a different stream will be sent to provide a high quality viewport. The more viewports there are available, the more efficient each bitstream can be generated (and the easier it is to deliver on congested networks, mobile networks, and the like).

For example, referring to FIGS. 1 and 2A, the portion of omnidirectional video 240 could be viewed on a first device (e.g., viewing device 120) based on a view point of the user of the first device at a first time period. The user of the first device could change the view point to causing the portion of omnidirectional video 250 to be communicated to the first device, rendered by the first device and viewed by the user of the first device at a second time period. The portion of omnidirectional video 245 could be communicated to the first device, rendered by the first device and viewed by the user of the first device during a transition time period between the first time period and the second time period.

Over a similar time frame, the portion of omnidirectional video 255 could be viewed on a second device (e.g., device 125) based on a view point of the user of the second device at a first time period, the user of the second device could change the view point to causing the portion of omnidirectional video 265 to be communicated to the second device, rendered by the second device and viewed by the user of the second device at a second time period

In order to reduce the core network bit rate, a full omnidirectional view format can be communicated over the core network. This format can be any 2D representation that has an omnidirectional equivalent (e.g., equirectangular, multiple fish-eye views, cube maps, original camera output, and the like). At the end of the core network (e.g., an access network/ingress network, a content delivery network edge node, or the like) a computing node is available to transform the full omnidirectional view in N different viewport representations that fit the viewing device. This can allow the viewing device to select the required viewport while limiting the bit rate for the viewing device. In an example implementation, the omnidirectional video can be mapped to a 2D representation and be encoded as the output video. Streams can have different encoding technologies applied (e.g. H.264, VP9 and the like). In case video compression is applied, the computing node decodes the input data. The next step converts the omnidirectional video data in the applicable representation and encodes the applicable representation.

Continuing the example above, typically a streaming device encodes the portion of the frame of the omnidirectional video and communicates the encoded portion to the rendering device (via any number of intervening nodes (e.g., intermediate devices 110-1, 110-2, 110-3)). In other words, streaming device 105 maps the omnidirectional video frame to the 2D cubic representation, selects the portion of the frame of the omnidirectional video 240, encodes the portion of the frame of the omnidirectional video 240 and communicates the encoded portion of the frame of the omnidirectional video 240 to viewing device 120. This process is repeated over and over for all of the viewing devices 115-1, 115-2, 115-3 viewing the streaming omnidirectional video. Assuming each of the viewing devices 115-1, 115-2, 115-3 are viewing at different points of view, resources of the streaming device 105 can be significantly over utilized and may not be capable of providing the desired viewing experience to the viewing devices 115-1, 115-2, 115-3.

However, according to an example implementation, the streaming device 105 can stream the omnidirectional video to each of the intermediate devices 110-1, 110-2, 110-3. In other words, the streaming device 105 can map the omnidirectional video frame to the 2D cubic representation, encode the frame of the omnidirectional video and communicate the encoded frame of the omnidirectional video to the intermediate devices 110-1, 110-2, 110-3. Or, the streaming device 105 can stream portions of the omnidirectional video corresponding to camera views (e.g., that which is captured by each camera forming a omnidirectional camera) to each of the intermediate devices 110-1, 110-2, 110-3. Each of the intermediate devices 110-1, 110-2, 110-3 can then decode the 2D cubic representation and map the decoded 2D cubic representation back into the frame of the omnidirectional video. Or, each of the intermediate devices 110-1, 110-2, 110-3 can then decode and stitch the portions of the omnidirectional video to generate the omnidirectional video. Further, the intermediate devices 110-1, 110-2, 110-3 can select and stream the portion of the omnidirectional video to the viewing devices 115-1, 115-2, 115-3 associated with the intermediate devices 110-1, 110-2, 110-3 that are viewing the streaming omnidirectional video.

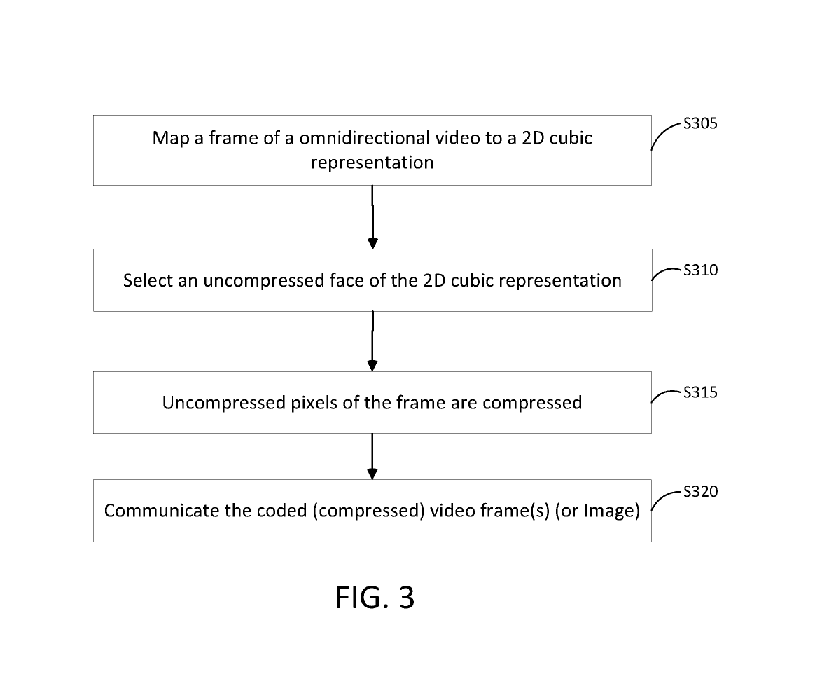

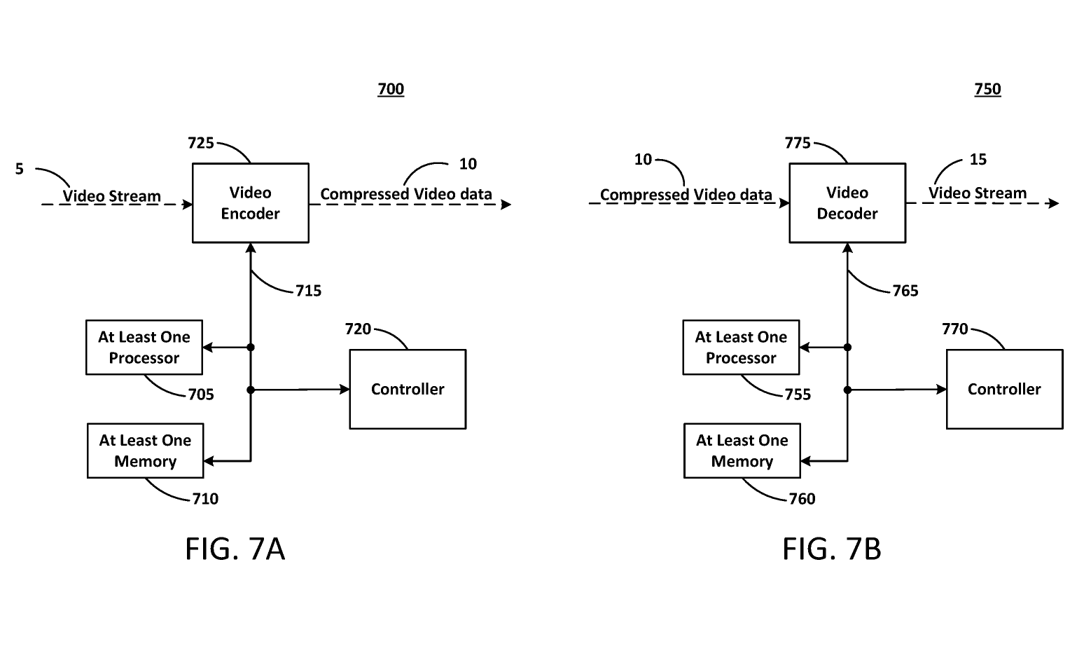

FIGS. 3-6 are flowcharts of methods according to example embodiments. The steps described with regard to FIGS. 3-6 may be performed due to the execution of hardware module or software code stored in a memory (e.g., at least one memory 710. 760) associated with an apparatus (e.g., as shown in FIGS. 7A and 7B) and executed by at least one processor (e.g., at least one processor 705, 755) associated with the apparatus. However, alternative embodiments are contemplated such as a system embodied as a special purpose processor. Although the methods described below are described as being executed by a processor, the methods (or portions thereof) are not necessarily executed by a same processor. In other words, at least one processor may execute the methods described below with regard to FIGS. 3-6.

FIGS. 3-6 are flowcharts of methods for encoding/decoding a streaming video frame according to at least one example embodiment. FIG. 3 is a flowchart of a method for encoding a streaming omnidirectional video frame according to at least one example embodiment. As shown in FIG. 3, in step S305 a frame of a omnidirectional video is mapped to a 2D cubic representation. For example, FIG. 2B illustrates the sphere 205 illustrated in FIG. 2A as a 2D cubic representation. The mapping can include mapping the frame of a omnidirectional video to a 2D representation based on a spherical to square projection. In this example, the 2D representation can be a plurality of squares each representing a face of a cube. The sphere 205 can be projected onto each square in the 2D representation using a quadrilateralized spherical cube projection algorithm or curvilinear projection.

If the encoder (e.g., video encoder 725 described below) is implemented in the streaming device 105, the whole frame of the omnidirectional video (and subsequently each frame of the streaming omnidirectional video) is mapped to the 2D cubic representation. Further, each face 210, 215, 220, 225, 230, 235 of the cube (e.g., each square) is subsequently encoded.

However, if the encoder (e.g., video encoder 725) is implemented in an intermediate device 110-1, 110-2, 110-3, sphere 205 can be translated such that a portion of the frame of the omnidirectional video to be encoded (e.g., based on a view point of a viewing device 115-1, 115-2, 115-3) is advantageously positioned at a center of a face 210, 215, 220, 225, 230, 235 of the cube. For example, sphere 205 can be translated such that a center of the portion of the frame of the omnidirectional video 240 could be positioned at pole A (pole B, point C, point D, point E, or point F). Then, the portion of the frame of the omnidirectional video (and subsequently each frame of the streaming omnidirectional video while portion 240 is selected) associated with face 230 is mapped to the 2D cubic representation. Face 230 is subsequently encoded.

In step S310 an uncompressed face of the 2D cubic representation is selected. For example, the encoder can have a default order for encoding each face 210, 215, 220, 225, 230, 235 of the cube. The implemented order is a same order to be used by a decoder for decoding the frame. As discussed above, if the encoder (e.g., video encoder 725 described below) is implemented in the streaming device 105, each face 210, 215, 220, 225, 230, 235 of the cube is selected and subsequently encoded. However, if the encoder (e.g., video encoder 725) is implemented in an intermediate device 110-1, 110-2, 110-3, some portion of the faces 210, 215, 220, 225, 230, 235 of the cube may be selected based on the portion of the frame of the omnidirectional video (e.g., portion 240) to be communicated to one or more of the viewing devices 115-1, 115-2, 115-3 (e.g., based on the view point).

In step S315 the uncompressed pixels of the video sequence frame are compressed using a video encoding operation. As an example H.264, HEVC, VP9 or any other video compression scheme can be used.

In step S320 the coded (compressed) video frame(s) are communicated. For example, the controller 720 may output the coded video (e.g., as coded video frames) to one or more output devices. The controller 720 may output the coded video as a single motion vector and a single set of predictor values (e.g., residual errors) for the macroblock. The controller 720 may output information indicating the video compression technology used in intra-prediction and/or an inter-prediction coding by the encoder 725. For example, the coded (compressed) video frame(s) may include a header for transmission. The header may include, amongst other things, the information indicating the video compression technology used in coding by the encoder. The video compression technology may be communicated with the coded (compressed) video frame(s) (e.g., in the header). The communicated video compression technology may indicate parameters used to convert each frame to a 2D cubic representation. The communicated coding scheme or mode may be numeric based (e.g., mode 101 may indicate a quadrilateralized spherical cube projection algorithm).

As discussed above, at the end of the core network (e.g., an access network/ingress network, a content delivery network edge node, or the like) a computing node is available to transform the full omnidirectional view in N different viewport representations configured to be (e.g., sized) rendered on a display of the viewing device. As such, the computing device at the end of the core network encodes the viewports (e.g., a plurality of portions of the omnidirectional video selected based on view points) for streaming to viewing devices. In other words, if video encoder 725 is implemented in an intermediate device 110-1, 110-2, 110-3, the intermediate device 110-1, 110-2, 110-3 can generate a plurality of viewports that stream encoded video data to the viewing devices 115-1, 115-2, 115-3 where a particular viewport is selected based on a view point of the viewing devices. In other words, intermediate device 110-1 can generate a plurality of viewports each streaming a portion of the omnidirectional video to any of the viewing devices 115-1. Further, viewing device 120 can select a viewport by communicating an indication of a view point to intermediate device 110-1.

Further, omnidirectional video encoding can require a large amount of calculations utilizing resources of the device encoding the video (e.g., intermediate device 110-1, 110-2, 110-3). For example, reference frame selection, quantization parameter selection, motion estimation, mode decisions (inter/intra prediction and block size) can require a large amount of calculations utilizing resources of the intermediate device 110-1, 110-2, 110-3. To select the optimal encoding decision a rate-distortion optimization can be applied. The rate-distortion optimization uses at least one of information based on encoding a previous frame, and information from the previously encoded representation of the same frame of the omnidirectional video and a trained hierarchical algorithm. Alternatively (or in addition to), a probabilistic approach can be applied to encode the most likely directions of view ahead of time to reduce latency overhead. The probabilities can be calculated from either user data (e.g. past history) or can be predicated from a saliency prediction model which looks to identify the most interesting areas of the frame. Some approach of evaluation all block sizes with all modes and all motion vectors would be infeasible to encode video real-time (e.g., streaming of a live concert event, a live sporting event, and the like). As a result, encoders can be optimized to estimate the optimal predictions. The better the estimation, the lower the bit rate.

According to an example implementation for encoding omnidirectional video transcoding architecture, the omnidirectional video input provides prior knowledge of the optimal decisions for the whole omnidirectional video. In other words, when encoding real-time video, encoding a frame of omnidirectional video can use information about a previous encoding process frames when encoding a current frame. Therefore, the encoder (e.g., encoder 725 when implemented in the intermediate device 110-1, 110-2, 110-3) can re-use this information to reduce the search space (e.g., the available options selected for use in reference frame selection, motion estimation, Mode decisions, and the like) to limit the required computations.

For example, the selections for the selected viewport bitstream could be altered based on some network and/or play back conditions (e.g., bandwidth or quality). Using the prior encoding information, decisions for new selections for lower quality video could result in larger block size selections to compensate for the higher quantization or if the video is at a higher resolution, the block sizes might need to be scaled (and or combined afterwards to compensation for higher quantization). Further, motion vectors and blocks might need to be rescaled to a different projection (e.g. original cube map, output truncated square pyramid, or the like).

Analyzing this knowledge of previously encoded frames can reduce a number of computations at the encoder utilizing few computing resources. However, the analytical operation requires an effective model between input and output selection. This model can be heuristically designed or can be generated and modified based on a hierarchical algorithm developed from a known initialization, for example of a hierarchical function or basis. In some of these embodiments, the hierarchical function or basis can be for example Haar wavelets or one or more pre-trained hierarchical algorithms or sets of hierarchical algorithms. In at least one embodiment, providing a known initialization allows the training of hierarchical algorithms to be accelerated, and the known initialization can be closer to the best solution especially when compared to starting from a random initialization.

In some embodiments, a trained hierarchical algorithm can be developed for input encoding parameter data, wherein the trained hierarchical algorithm is developed for that input encoding parameter data based on the selected most similar pre-trained algorithm. In at least one embodiment, the selection of the one or more similar pre-trained algorithm(s) can be made based on one or more metrics associated with the pre-trained models when compared and/or applied to the input data. In some embodiments, metrics can be any predetermined measure of similarity or difference. In some embodiments, the most similar pre-trained algorithm can be used as a starting point for developing a trained or tailored algorithm for the input data as a tailored algorithm does not have to undergo as extensive development as needed when developing an algorithm from first principles.

After training the model, the model can be used to optimize encoder input based on this knowledge of previously encoded frames. Machine learning techniques can be used to train the model. Machine learning is the field of study where a computer or computers learn to perform classes of tasks using the feedback generated from the experience or data gathered that the machine learning process acquires during computer performance of those tasks. Typically, machine learning can be broadly classed as supervised and unsupervised approaches, although there are particular approaches such as reinforcement learning and semi-supervised learning which have special rules, techniques and/or approaches. Supervised machine learning is concerned with a computer learning one or more rules or functions to map between example inputs and desired outputs as predetermined by an operator or programmer, usually where a data set containing the inputs is labelled. Unsupervised learning is concerned with determining a structure for input data, for example when performing pattern recognition, and typically uses unlabeled data sets. Reinforcement learning is concerned with enabling a computer or computers to interact with a dynamic environment, for example when playing a game or driving a vehicle. Various hybrids of these categories are possible, such as “semi-supervised” machine learning where a training data set has only been partially labelled.

For unsupervised machine learning, there is a range of possible applications such as, for example, the application of computer vision techniques to image processing or video enhancement. Unsupervised machine learning is typically applied to solve problems where an unknown data structure might be present in the data. As the data is unlabeled, the machine learning process is required to operate to identify implicit relationships between the data for example by deriving a clustering metric based on internally derived information. For example, an unsupervised learning technique can be used to reduce the dimensionality of a data set and attempt to identify and model relationships between clusters in the data set, and can for example generate measures of cluster membership or identify hubs or nodes in or between clusters (for example using a technique referred to as weighted correlation network analysis, which can be applied to high-dimensional data sets, or using k-means clustering to cluster data by a measure of the Euclidean distance between each datum).

Semi-supervised learning is typically applied to solve problems where there is a partially labelled data set, for example where only a subset of the data is labelled. Semi-supervised machine learning makes use of externally provided labels and objective functions as well as any implicit data relationships.

When initially configuring a machine learning system, particularly when using a supervised machine learning approach, the machine learning algorithm can be provided with some training data or a set of training examples, in which each example is typically a pair of an input signal/vector and a desired output value, label (or classification) or signal. The machine learning algorithm analyses the training data and produces a generalized function that can be used with unseen data sets to produce desired output values or signals for the unseen input vectors/signals. The user needs to decide what type of data is to be used as the training data, and to prepare a representative real-world set of data. The user must however take care to ensure that the training data contains enough information to accurately predict desired output values without providing too many features (which can result in too many dimensions being considered by the machine learning process during training, and could also mean that the machine learning process does not converge to good solutions for all or specific examples). The user must also determine the desired structure of the learned or generalized function, for example whether to use support vector machines or decision trees.

A bitrate penalty occurs when an encoder encodes the omnidirectional video at less than an optimal quality. In other words, more bits are spent than necessary to transmit the video at a given quality. The bit rate penalty usually occurs as a result of wrong encoder decision (motion vectors, quantization parameters, reference frames, block sizes, prediction modes, and the like). The model used to reduce the search space can be modified to generate a (prioritized) list of decisions that should be evaluated. This will increase the probability that the optimal decision is made and hence the bitrate penalty is reduced.

In one example implementation, evaluation of the prioritized list can stop when the cost of prediction increases (e.g., a less optimal rate distortion optimization) for the next decision in the list. In another example implementation, evaluation of the prioritized list can stop when a probability threshold is met. The probability threshold can be calculated by the model used to reduce the search space in that the model predicts which decision should be in the prioritized list. Further, a motion vector refinement can be applied, for example, when a certain motion vector is predicted. The algorithm can apply a motion vector estimation around this predicted motion vector to search for better matches at pixel and sub-pixel level.

As discussed above the intermediate device 110-1, 110-2, 110-3 can encode N viewports. Two or more of the N viewports can be adjacent or overlapping to each other. For example, referring to FIG. 2A, portion 255 can be adjacent to portion 260. Accordingly, a viewport corresponding to portion 255 can be adjacent to a viewport corresponding to portion 260. Adjacent or overlapping portions of video may have similar characteristics regarding encoding the portions of omnidirectional video. Therefore, a viewport can benefit from previously calculated encoder decision for an adjacent viewport. Further, co-located and/or proximate intermediate device 110-1, 110-2, 110-3 can share encoder decisions for viewports corresponding to a same portion of omnidirectional video across different intermediate devices 110-1, 110-2, 110-3. Further, the encoding decisions can be generated by a core network component (not shown) or a one of the intermediate devices 110-1, 110-2, 110-3 that sends this information as metadata to all the intermediate devices 110-1, 110-2, 110-3, such that all intermediate devices 110-1, 110-2, 110-3 can reduce the computational complexity.

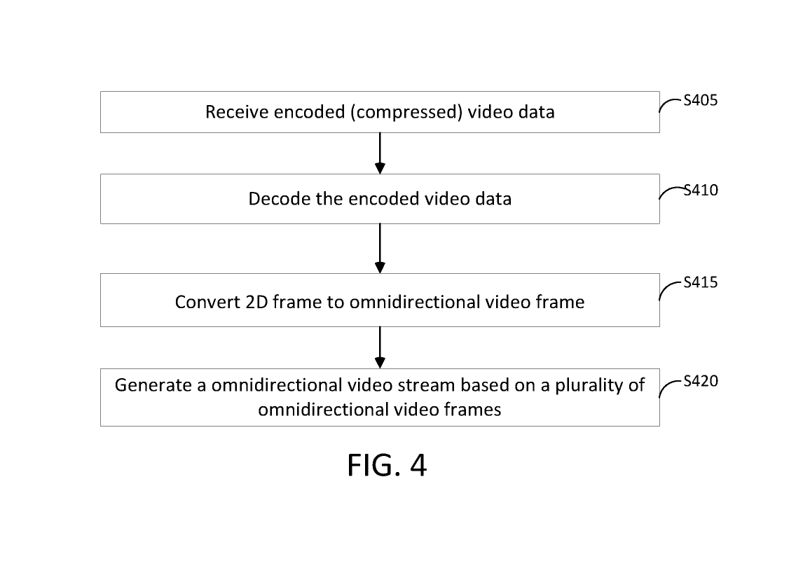

FIG. 4 is a flowchart of a method for decoding a streaming omnidirectional video frame according to at least one example embodiment. As shown in FIG. 4, in step S405 encoded (compressed) video data is received. For example, the encoded (compressed) video data may be a previously encode (e.g., by video encoder 725) real time omnidirectional video stream (e.g., a concert or sporting event recording) received via communication network (e.g., Internet or Intranet). For example, the video stream may also be a previously recorded video (e.g., a movie or a video recorder recording). The coded (compressed) video frame(s) may include a header for transmission. The header may include, amongst other things, the information indicating the video compression technology used in coding by the encoder. For example, the video compression technology may indicate parameters used to convert each frame to a 2D cubic representation.

In step S410 the compressed pixels of the video sequence frame are decoded/decompressed using a video decoding operation. As an example H.264, HEVC, VP9 or any other video compression scheme can be used.

In step S420 the 2D frame is converted to a omnidirectional video frame. For example, the 2D frame can be converted using the inverse of the technique described above with regard to mapping a omnidirectional video frame to a 2D representation of the omnidirectional video frame. In step S425 a omnidirectional video stream is generated based on a plurality of omnidirectional video frame. For example, at least two video frames of reconstructed converted frames may be organized in a sequence to form a omnidirectional video stream.

The omnidirectional video can be streamed to viewing devices with varying resolution or quality. For example, a viewing area surrounding the viewable portion can be encoded by intermediate device 110-1, 110-2, 110-3 and communicated to the viewing device 115-1, 115-2, 115-3. The viewing area surrounding the viewable portion can be encoded to have a lower resolution than the viewable portion. As another example, the intermediate device 110-1, 110-2, 110-3 can predict at least one likely next view point of a user of the viewing device 115-1, 115-2, 115-3. Then the intermediate device 110-1, 110-2, 110-3 can encode and communicate a viewport based on the at least one predicted view point. The predicted viewport can be encoded to have a lower resolution than the currently viewed viewport. By using a lower resolution for the communication of video data outside of the currently viewed viewport, the video data can be communicated using a lower overall bandwidth.

According to example implementations, the decoder can use super resolution techniques to increase the resolution of the reduced resolution portions of the omnidirectional video. In other words, the decoder can use super resolution techniques to increase the resolution of the viewport area to a higher resolution such the perceived quality is improved. In an example implementation, multiple low-resolution frames can be gathered together and sub-pixel convolutions or transposed convolutions can be applied between the individual frames to create a higher resolution image than the original. In such embodiments, a series of frames can be combined to form a higher resolution video than was originally received by the viewing device.

In some embodiments, learning techniques and convolutional neural network models can be used to generate higher resolution video. The convolutional neural network models (or hierarchical algorithms) can be transmitted along with the low-resolution frames of video data. Machine learning with deep learning techniques can create non-linear representations of an image or sequence of images. In at least one implementation, super resolution techniques are employed to create a specific model using machine learning for each frame, so that the model can be used to substantially recreate the original (or higher) resolution version of a lower-resolution frame and trained using machine learning based on knowledge of the original-resolution frame. This is termed the training and optimization process. In some embodiments, generic models can be developed for types of scene or frame. Alternatively, models can be developed for each scene. When using machine learning and sparse coding principles, a training process is used to find optimal representations that can best represent a given signal, subject to predetermined initial conditions such as a level of sparsity.

The convolutional neural network models can also be referred to as filters. In an example implementation, the encoder may down-sample the portion of video using a convolution, filter or filter mask based on a trained convolutional neural network model. The encoded viewport corresponding to the current view point can down-sample less than the encoded viewport(s) not corresponding to the current view point. The decoder can use super resolution techniques to increase the resolution by applying convolution, filter or filter mask configured to up-sample the viewport(s) not corresponding to the current view point more than those that are. According to an example implementation, the encoder can include a pre-processing (e.g., a process performed before encoding) that utilizes the trained model and the decoder can post-process the decoded omnidirectional video utilizing the trained model.

In some implementations, the encoder (e.g., when implemented in the intermediate device 110-1, 110-2, 110-3) and the decoder (the viewing device 115-1, 115-2) can form a system, sometimes referred to as an auto-encoder, that uses convolutional neural network models instead of traditional encoders (e.g., transform, entropy and quantization as in e.g. H.264, VP9 and the like). Accordingly, the viewport corresponding to the current view point can use a different convolutional neural network model than the viewport(s) not corresponding to the current view point. The viewport corresponding to the current view point can use a convolutional neural network resulting in a higher resolution when decoded. The convolutional neural network(s) can be trained using the learning techniques described above.

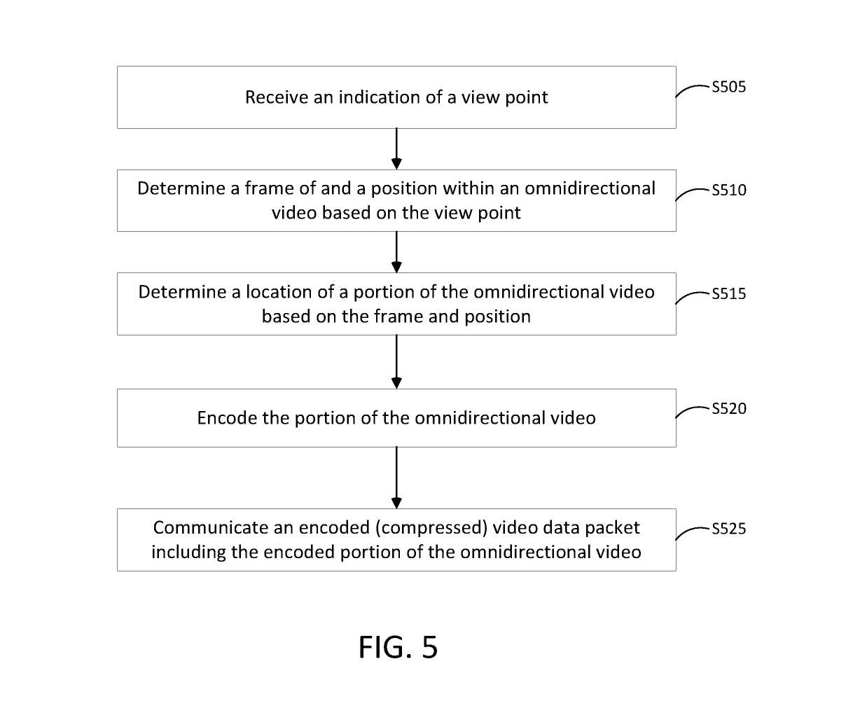

FIG. 5 is a flowchart of a method for encoding a streaming omnidirectional video frame according to at least one example embodiment. As shown in FIG. 5, in step S505 an indication of a view point is received. For example, the indication of the view point can be received from a device executing a playing back of the omnidirectional video (e.g., viewing devices 115-1, 115-2, 115-3). In other words, the indication of the view point can be received from a device implementing a decoder (e.g., decoder 775 when implemented in viewing devices 115-1, 115-2, 115-3) in order for a viewer to view the omnidirectional video. For example, the indication of a view point can be based on a portion of a omnidirectional video that a viewer is currently looking at (e.g., portion 240 or the center of portion 240). The indication can be, for example, a point (e.g., the center of portion 240) or position (e.g., longitude and latitude) on the sphere 205, a plurality of points on the sphere, or a side of a cube representing the sphere 205.

In an example implementation, the indication of a view point is received before the omnidirectional video frame is mapped to a 2D cubic representation. In this implementation, the omnidirectional video frame can be rotated such that the view point is centered along, for example, a pole (e.g., pole A or the line at the center of the sphere 205 (e.g., along the equator). As a result, the pixels, blocks and/or macro-blocks (e.g., that make up the portion of the omnidirectional video) can be in a position such that any distortion of the pixels, blocks and/or macro-blocks during a projection of the pixels, blocks and/or macro-blocks onto the surface of the cube can be minimized, e.g., through rotation the omnidirectional video to align with a 2D projected surface (such as a cube map).

In step S510 a frame of and a position within a omnidirectional video based on the view point is determined. For example, if the indication is a point or position (e.g., the center of portion 240) on the sphere (as a omnidirectional video frame), a number of pixels, a block and/or a macro-block can be determined based on the view point. In an example implementation, the position can be a centered on the point (e.g., the center of portion 240) or position. The frame can be a next frame in the stream. However, in some implementations, frames can be queued on the viewing device (e.g., viewing devices 115-1, 115-2, 115-3). Therefore, a number of frames in the queue may need to be replaced when the viewer changes a view point. Therefore, the determined frame can be a frame (e.g., first frame to be replaced) in the queue.

In step S515 a location of a portion of the omnidirectional video based on the frame and position is determined. For example, within the selected frame, a portion of the omnidirectional video can include a plurality of pixels or blocks of pixels. In one implementation, the portion of the omnidirectional video can be generated based on the view point to include the plurality of pixels or blocks included in a square or rectangle centered on the view point or determined position. The portion of the omnidirectional video can have a length and width based on the viewing devices 115-1, 115-2, 115-3. For example, the length and width of the portion of the omnidirectional video can be only what is needed for rendering on the viewing devices 115-1, 115-2, 115-3. However, the length and width of the portion of the omnidirectional video can be only what is needed for rendering on the viewing devices 115-1, 115-2, 115-3 plus a border region around the portion of omnidirectional video. The border region around the portion of omnidirectional video can be configured to allow for small deviations in the view point.

In step S520 the portion of the omnidirectional video is encoded. For example, the portion of the omnidirectional video may be transformed (encoded or compressed) into transform coefficients using a configured transform (e.g., a KLT, a SVD, a DCT or an ADST). The transformed coefficients can then be quantized through any reasonably suitable quantization techniques. In addition, entropy coding may be applied to, for example, assign codes to the quantized motion vector codes and residual error codes to match code lengths with the probabilities of the quantized motion vector codes and residual error codes, through any entropy coding technique.

In step S525 an encoded (compressed) video data packet including the encoded portion of the omnidirectional video is communicated. For example, the controller 720 may output the coded video (e.g., as coded video frames) as one or more data packets to one or more output devices. The packet may include compressed video bits 10. The packet may include the encoded portion of the omnidirectional video. The controller 720 may output the coded video as a single motion vector and a single set of predictor values (e.g., residual errors) for the macroblock. The controller 720 may output information indicating the mode or scheme used in intra-prediction and/or an inter-prediction coding by the encoder 725. For example, the coded (compressed) video frame(s) and/or the data packet may include a header for transmission. The header may include, amongst other things, the information indicating the mode or scheme used in coding by the encoder. The coding scheme or mode may be communicated with the coded (compressed) video frame(s) (e.g., in the header). The communicated coding scheme or mode may indicate parameters used to convert each frame to a 2D cubic representation. The communicated coding scheme or mode may be numeric based (e.g., mode 101 may indicate a quadrilateralized spherical cube projection algorithm).

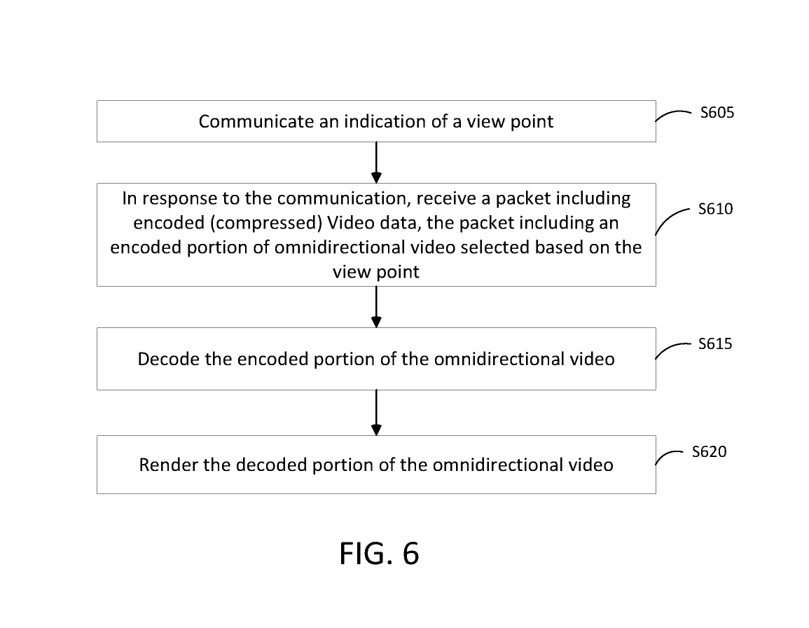

FIG. 6 is a flowchart of a method for decoding a streaming omnidirectional video frame according to at least one example embodiment. As shown in FIG. 6, in step S605 an indication of a view point is communicated. For example, the indication of the view point can be communicated by a device executing a playing back of the omnidirectional video (e.g., viewing devices 115-1, 115-2, 115-3). In other words, the indication of the view point can be communicated by a device implementing a decoder (e.g., decoder 775 when implemented in viewing devices 115-1, 115-2, 115-3) in order for a viewer to view the omnidirectional video. For example, the indication of a view point can be based on a portion of a omnidirectional video that a viewer is currently looking at (e.g., portion 240 or the center of portion 240). The indication can be, for example, a point (e.g., the center of portion 240) or position (e.g., longitude and latitude) on the sphere 205, a plurality of points on the sphere, a side of a cube representing the sphere 205 or some other position from which the view point can be determined.

In step S610 in response to the communication, a packet including encoded (compressed) video data is received, the packet including an encoded portion of omnidirectional video selected based on the view point. For example, the packet may include compressed video bits 10. The packet may include a header for transmission. The header may include, amongst other things, the information indicating the mode or scheme used in intra-frame and/or inter-frame coding by the encoder. The header may include information indicating parameters used to convert a frame of the omnidirectional video to a 2D cubic representation. The header may include information indicating parameters used to achieve a bandwidth or quality of the encoded portion of omnidirectional video.

In step S615 the encoded portion of the omnidirectional video is decoded. For example, a video decoder (e.g., decoder 775) entropy decodes the encoded portion of the omnidirectional video (or encoded 2D representation) for example, Context Adaptive Binary Arithmetic Decoding to produce a set of quantized transform coefficients. The video decoder de-quantizes the transform coefficients given by the entropy decoded bits. For example, the entropy decoded video bits can be de-quantized by mapping values within a relatively small range to values in a relatively large range (e.g. opposite of the quantization mapping described above). Further, the video decoder inverse transforms the video bits using an indicated (e.g., in the header) transform (e.g., a KLT, a SVD, a DCT or an ADST). The video decoder can filter the reconstructed pixel in the video frame. For example, a loop filter can be applied to the reconstructed block to reduce blocking artifacts. For example, a deblocking filter can be applied to the reconstructed block to reduce blocking distortion. Decoding the encoded portion of the omnidirectional video (or 2D representation) can include using bandwidth or quality variables as input parameters for the decoding scheme, codec or video compression technology.

In step S620 the decoded portion of the omnidirectional video is rendered. For example, the decoded portion of the omnidirectional video can be sent as a sequential set of frames (or frame portions) to a controller for display on a computer screen associated with a viewing device (e.g., viewing devices 115-1, 115-2, 115-3). In an example implementation, the viewing devices 115-1, 115-2, 115-3 can be a head mount display configured to display a omnidirectional video.

FIG. 7A illustrates a video encoder system according to at least one example embodiment. In the example of FIG. 7A, a video encoder system 700 may be, or include, at least one computing device and can represent virtually any computing device configured to perform the methods described herein. As such, the video encoder system 700 can include various components which may be utilized to implement the techniques described herein, or different or future versions thereof. By way of example, the video encoder system 700 is illustrated as including at least one processor 705, as well as at least one memory 710.

As shown in FIG. 7A, the video encoder system 700 includes the at least one processor 705, the at least one memory 710, a controller 720, and a video encoder 725. The at least one processor 705, the at least one memory 710, the controller 720, and the video encoder 725 are communicatively coupled via bus 715.

The at least one processor 705 may be utilized to execute instructions stored on the at least one memory 710, so as to thereby implement the various features and functions described herein, or additional or alternative features and functions. The at least one processor 705 and the at least one memory 710 may be utilized for various other purposes. In particular, the at least one memory 710 can represent an example of various types of memory (e.g., a non-transitory computer readable storage medium) and related hardware and software which might be used to implement any one of the modules described herein.

The at least one memory 710 may be configured to store data and/or information associated with the video encoder system 700. For example, the at least one memory 710 may be configured to store codecs associated with intra-prediction, filtering and/or mapping omnidirectional video to 2D representations of the omnidirectional video. The at least one memory 710 may be a shared resource. For example, the video encoder system 700 may be an element of a larger system (e.g., a server, a personal computer, a mobile device, and the like). Therefore, the at least one memory 710 may be configured to store data and/or information associated with other elements (e.g., image/video serving, web browsing or wired/wireless communication) within the larger system.

The controller 720 may be configured to generate various control signals and communicate the control signals to various blocks in video encoder system 700. The controller 720 may be configured to generate the control signals to implement the techniques described herein. The controller 720 may be configured to control the video encoder 725 to encode video data, a video frame, a video sequence, a streaming video, and the like according to example embodiments. For example, the controller 720 may generate control signals corresponding to inter-prediction, intra-prediction and/or mapping omnidirectional video to 2D representations of the omnidirectional video. The video encoder 725 may be configured to receive a video stream input 5 and output compressed (e.g., encoded) video bits 10. The video encoder 725 may convert the video stream input 5 into discrete video frames.

The compressed video data 10 may represent the output of the video encoder system 700. For example, the compressed video data 10 may represent an encoded video frame. For example, the compressed video data 10 may be ready for transmission to a receiving device (not shown). For example, the compressed video data 10 may be transmitted to a system transceiver (not shown) for transmission to the receiving device.

The at least one processor 705 may be configured to execute computer instructions associated with the controller 720 and/or the video encoder 725. The at least one processor 705 may be a shared resource. For example, the video encoder system 700 may be an element of a larger system (e.g., a server, a mobile device and the like). Therefore, the at least one processor 705 may be configured to execute computer instructions associated with other elements (e.g., image/video serving, web browsing or wired/wireless communication) within the larger system.

FIG. 7B illustrates a video decoder system according to at least one example embodiment. In the example of FIG. 7B, a video decoder system 750 may be at least one computing device and can represent virtually any computing device configured to perform the methods described herein. As such, the video decoder system 750 can include various components which may be utilized to implement the techniques described herein, or different or future versions thereof. By way of example, the video decoder system 750 is illustrated as including at least one processor 755, as well as at least one memory 760.

Thus, the at least one processor 755 may be utilized to execute instructions stored on the at least one memory 760, so as to thereby implement the various features and functions described herein, or additional or alternative features and functions. The at least one processor 755 and the at least one memory 760 may be utilized for various other purposes. In particular, the at least one memory 760 may represent an example of various types of memory (e.g., a non-transitory computer readable storage medium) and related hardware and software which might be used to implement any one of the modules described herein. According to example embodiments, the video encoder system 700 and the video decoder system 750 may be included in a same larger system (e.g., a personal computer, a mobile device and the like). The video decoder system 750 can be configured to perform the opposite or reverse operations of the encoder 700.

The at least one memory 760 may be configured to store data and/or information associated with the video decoder system 750. For example, the at least one memory 710 may be configured to store inter-prediction, intra-prediction and/or mapping omnidirectional video to 2D representations of the omnidirectional video. The at least one memory 760 may be a shared resource. For example, the video decoder system 750 may be an element of a larger system (e.g., a personal computer, a mobile device, and the like). Therefore, the at least one memory 760 may be configured to store data and/or information associated with other elements (e.g., web browsing or wireless communication) within the larger system.

The controller 770 may be configured to generate various control signals and communicate the control signals to various blocks in video decoder system 750. The controller 770 may be configured to generate the control signals in order to implement the video decoding techniques described below. The controller 770 may be configured to control the video decoder 775 to decode a video frame according to example embodiments. The controller 770 may be configured to generate control signals corresponding to prediction, filtering and/or mapping between omnidirectional video to 2D representations of the omnidirectional video. The video decoder 775 may be configured to receive a compressed (e.g., encoded) video data 10 input and output a video stream 15. The video decoder 775 may convert discrete video frames of the compressed video data 10 into the video stream 15.

The at least one processor 755 may be configured to execute computer instructions associated with the controller 770 and/or the video decoder 775. The at least one processor 755 may be a shared resource. For example, the video decoder system 750 may be an element of a larger system (e.g., a personal computer, a mobile device, and the like). Therefore, the at least one processor 755 may be configured to execute computer instructions associated with other elements (e.g., web browsing or wireless communication) within the larger system.

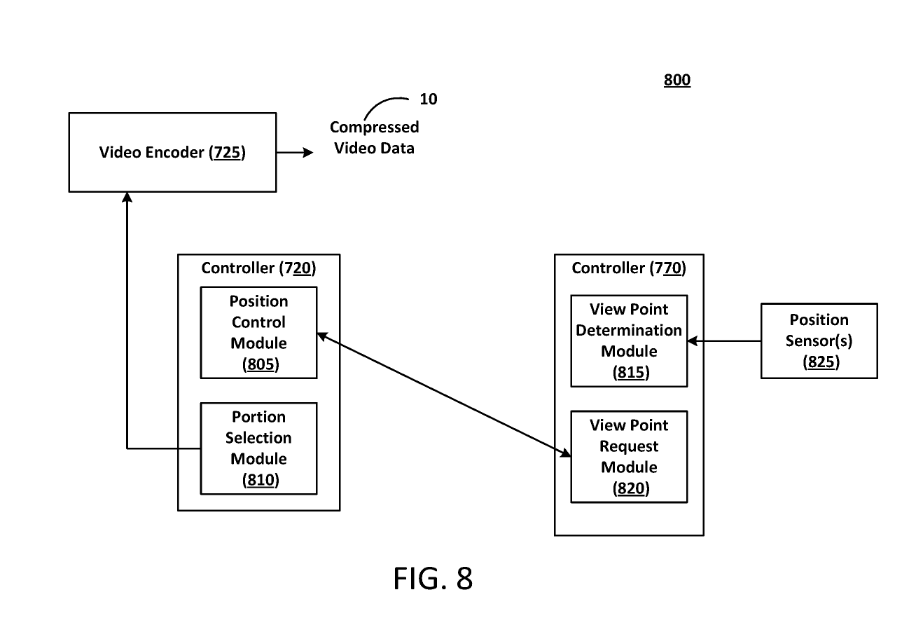

FIG. 8 illustrates a system 800 according to at least one example embodiment. As shown in FIG. 8, the system 800 includes the controller 720, the controller 770, the encoder 725 and a position sensor 825. The controller 720 further includes a position control module 805 and a portion selection module 810. The controller 770 further includes a view point determination module 815 and a view point request module 520.

According to an example implementation, the position sensor 825 detects a position (or change in position) of a viewers eyes (or head), the view point determination module 815 determines a view point based on the detected position and the view point request module 820 communicates the view point as part of a request for a portion of a frame of omnidirectional video. According to another example implementation, the position sensor 825 detects a position (or change in position) based on an image panning position as rendered on a display. For example, a user may use a mouse, a track pad or a gesture (e.g., on a touch sensitive display) to select, move, drag, expand and/or the like a portion of the omnidirectional video as rendered on the display. The view point may be communicated together with a request for a portion of a frame of the omnidirectional video. The view point may be communicated separate from a request for a frame of the omnidirectional video. For example, the request for the frame of the omnidirectional video may be in response to a changed view point resulting in a need to replace previously requested and/or a queued frame.

The position control module 805 receives and processes the request for the portion of the frame of the omnidirectional video. For example, the position control module 805 can determine a frame and a position of the portion of the frame of the omnidirectional video based on the view point. Then the position control module 805 can instruct the portion selection module 810 to select the portion of the frame of the omnidirectional video. Selecting the portion of the frame of the omnidirectional video can include passing a parameter to the encoder 725. The parameter can be used by the encoder 725 during the encoding of the omnidirectional video. Accordingly, the position sensor 825 can be configured to detect a position (orientation, change in position and/or change in orientation) of a viewer's eyes (or head). For example, the position sensor 825 can include other mechanisms, such as, an accelerometer in order to detect movement and a gyroscope in order to detect position. Alternatively, or in addition to, the position sensor 825 can include a camera or infra-red sensor focused on the eyes or head of the viewer in order to determine a position of the eyes or head of the viewer. The position sensor 825 can be configured to communicate position and change in position information to the view point determination module 815.

The view position determination module 515 can be configured to determine a view point (e.g., a portion of a omnidirectional video that a viewer is currently looking at) in relation to the omnidirectional video. The view point can be determined as a position, point or focal point on the omnidirectional video. For example, the view point could be a latitude and longitude position on the omnidirectional video. The view point (e.g., latitude and longitude position or side) can be communicated to the position control module 805 using, for example, a Hypertext Transfer Protocol (HTTP).

The position control module 805 may be configured to determine a position based on the view point (e.g., frame and position within the frame) of the portion of the frame of the omnidirectional video. For example, the position control module 805 can select a square or rectangle centered on the view point (e.g., latitude and longitude position or side). The portion selection module 810 can be configured to select the square or rectangle as a block, or a plurality of blocks. The portion selection module 810 can be configured to instruct (e.g., via a parameter or configuration setting) the encoder 725 to encode the selected portion of the frame of the omnidirectional video.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof. It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

What is claimed is:

1. An edge node in a network comprising:
a processor configured to receive one of:
a first encoded video data representing an 2D representation of a frame of omnidirectional video, and
a second encoded video data representing a plurality of images each representing a section of the frame of omnidirectional video;
the processor is further configured to receive an indication of a view point on the omnidirectional video;
an encoder configured to:
select at least one portion of the omnidirectional video based on the view point, and
encode the selected portion of the omnidirectional video; and
the processor is further configured to communicate the encoded omnidirectional video in response to receiving the indication of the view point on the omnidirectional video.

2. The edge node of claim 1, further comprising:
a decoder configured to decode the second encoded video data to reconstruct the plurality of images, wherein the processor is further configured to generate the frame of omnidirectional video by stitching the plurality of images together.

3. The edge node of claim 1, further comprising:
a decoder configured to:
decode the first encoded video data to reconstruct the 2D representation of the frame of omnidirectional video, and
generate the frame of omnidirectional video by mapping the 2D representation of the frame of omnidirectional video to the frame of omnidirectional video.

4. The edge node of claim 1, wherein the frame of omnidirectional video is translated prior to encoding the selected portion of the omnidirectional video.

5. The edge node of claim 1, wherein
the encoder applies a rate-distortion optimization, and
the rate-distortion optimization uses at least one of information based on encoding a previous frame, and information from the previously encoded representation of a same frame of the omnidirectional video, and a trained hierarchical algorithm.

6. The edge node of claim 1, wherein
the encoder applies a rate-distortion optimization,
the encoder generates a list of decisions to be evaluated for rate-distortion optimization, and
the rate-distortion optimization uses at least one of information based on encoding a previous frame, and information from the previously encoded representation of a same frame of the omnidirectional video, or a trained hierarchical algorithm.

7. The edge node of claim 1, wherein
the encoder uses a trained convolutional neural network model to encode the selected portion of the omnidirectional video, and
the processor is further configured to communicate the trained convolutional neural network model with the encoded omnidirectional video.

8. The edge node of claim 1, wherein the encoder is implemented using a non-transitory computer readable medium having code segments stored thereon, the code segments being executed by the processor.

9. A method comprising:
receiving one of:
a first encoded video data representing an 2D representation of a frame of omnidirectional video, and
a second encoded video data representing a plurality of images each representing at least one portion of the frame of omnidirectional video;
receiving an indication of a view point on the omnidirectional video;
selecting a portion of the omnidirectional video based on the view point;
encoding the selected portion of the omnidirectional video; and
communicating the encoded omnidirectional video in response to receiving the indication of the view point on the omnidirectional video.

10. The method of claim 9, further comprising:
decoding the second encoded video data to reconstruct the plurality of images; and
generating the frame of omnidirectional video by stitching the plurality of images together.

11. The method of claim 9, further comprising:
decoding the first encoded video data to reconstruct the 2D representation of the frame of omnidirectional video; and
generating the frame of omnidirectional video by mapping the 2D representation of the frame of omnidirectional video to the frame of omnidirectional video.

12. The method of claim 9, wherein the frame of omnidirectional video is translated prior to encoding the selected portion of the omnidirectional video.

13. The method of claim 9, further comprising:
applying a rate-distortion optimization, wherein the rate-distortion optimization uses the rate-distortion optimization uses at least one of information based on encoding a previous frame, and information from the previously encoded representation of a same frame of the omnidirectional video, and a trained hierarchical algorithm.

14. The method of claim 9, further comprising
generating a list of decisions to be evaluated for a rate-distortion optimization, and
applying the rate-distortion optimization, wherein the rate-distortion optimization uses the list of decisions, the rate-distortion optimization uses at least one of information based on encoding a previous frame, and information from the previously encoded representation of a same frame of the omnidirectional video, or a trained hierarchical algorithm.

15. The method of claim 9, wherein
the encoding uses a trained convolutional neural network model to encode the selected portion of the omnidirectional video, and
communicating the trained convolutional neural network model with the encoded omnidirectional video.

16. The method of claim 9, wherein the method is implemented using a non-transitory computer readable medium having code segments stored thereon, the code segments being executed by a processor.

17. A viewing device comprising:
a processor configured to:
communicate a view point to an edge node in a network, and
receive encoded video data from the edge node in response to communicating the view point, the encoded video data representing a portion of a frame of omnidirectional video; and
a decoder configured to decode the encoded video data to reconstruct the portion of the frame of omnidirectional video.

18. The viewing device of claim 17, wherein
the processor is configured to receive a trained convolutional neural network model, and
the decoder is configured to decode the encoded video data using the trained convolutional neural network model.

19. The viewing device of claim 17, wherein the decoder is configured to use a super resolution technique to increase a resolution of the portion of the frame of omnidirectional video.

20. The viewing device of claim 17, wherein
the encoded video data represents a plurality of portions of the frame of omnidirectional video encoded a different resolutions,
the decoder is configured to generate a plurality of reconstructed portions of the frame of omnidirectional video, and
the decoder is configured to use a super resolution technique to increase a resolution of at least one of the plurality of reconstructed portions of the frame of omnidirectional video.
